(19) United States
(12) Patent Application Publication
(10) Pub. No.: US 2022/0296981 A1
(43) Pub. Date: Sep. 22, 2022

(54) Structure for Netted Yard Games

(71) Applicant: Mountainville Commerce LLC, Alpine, UT (US)

(72) Inventors: Bart Boggess, Alpine, UT (US); Ian Boggess, Alpine, UT (US)

(21) Appl. No.: 17/698,982

(22) Filed: Mar. 18, 2022

Related U.S. Application Data
(60) Provisional application No. 63/162,699, filed on Mar. 18, 2021.

(51) Int. Cl. A63B 71/02; E04H 17/16; E04H 17/14; E06B 11/02

(52) U.S. Cl. CPC A63B 71/022; E04H 17/16; E04H 17/1413; E06B 11/02

(57) ABSTRACT

A system includes horizontal elements, vertical elements, and a flexible partition. The horizontal elements form a multi-sided play area bounded by the horizontal elements. The vertical elements extend perpendicularly upward from ends of the horizontal elements. The flexible partition is coupled to the vertical elements to bound a perimeter of the multi-sided play area by forming panels extending between the vertical elements. Each panel has a height corresponding to a height of the vertical elements and a length corresponding to a length of the horizontal elements.

### CROSS-REFERENCE TO RELATED APPLICATIONS

The present application is a conversion of U.S. Provisional Application No. 63/162,699 entitled “STRUCTURE FOR NETTED YARD GAMES,” filed on 18 Mar. 2021. The entire contents of the above-identified application are hereby incorporated by reference for all purposes.

### BACKGROUND

With more neighborhoods becoming urbanized, there is a need for interactive games that can be played in the protection and security of one's own back yard or smaller outdoor or indoor spaces. Most popular organized sports (such as baseball, football, or soccer) require a significant number of players and a significantly large indoor or outdoor area where balls or other game implements can be used.

### BRIEF DESCRIPTION OF THE DRAWINGS

The present description will be understood more fully when viewed in conjunction with the accompanying drawings of various examples of netted yard games. The description is not meant to limit the netted yard games to the specific examples. Rather, the specific examples depicted and described are provided for explanation and understanding of netted yard games. Throughout the description the drawings may be referred to as drawings, figures, and/or FIGs.

FIG. 1 illustrates a perspective view of a structure for a netted yard game, according to an embodiment.

FIG. 2 illustrates an overhead view of the structure of FIG. 1, according to an embodiment.

FIG. 3 illustrates a sleeve attachment on a vertical element of the structure of FIG. 1, according to an embodiment.

FIG. 4 illustrates a tension attachment of the structure of FIG. 1, according to an embodiment.

FIG. 5 illustrates an end cap for a vertical element of the structure of FIG. 1, according to an embodiment.

FIG. 6 illustrates a gate element for the structure of FIG. 1, according to an embodiment.

### DETAILED DESCRIPTION

A structure for netter yard games, as disclosed herein, will become better understood through a review of the following detailed description, in conjunction with the figures. The detailed description and figures provide merely examples of the various embodiments of a structure for netter yard games. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional netted yard games come in many different shapes, sizes, and arrangements. Many conventional yard games are bulky and difficult to set up. As yard games typically require a relatively large amount of space, the structures involved can similarly be large, heavy, and difficult to transport and set up/take down. Frequently, an opportunity to take and use a yard game may be overshadowed by the amount of time and effort required to transport and setup/take down the yard game resulting in less use and enjoyment and a more negative overall user experience.

Implementations of the structure for netted games described herein may address some or all of the problems described above. For example, embodiments of the structure may be lighter, stronger, more intuitive in set up and take down and may be easier and/or more compact for transport. Embodiments described herein may provide a simple, lightweight, and intuitive structure for a netted yard game.

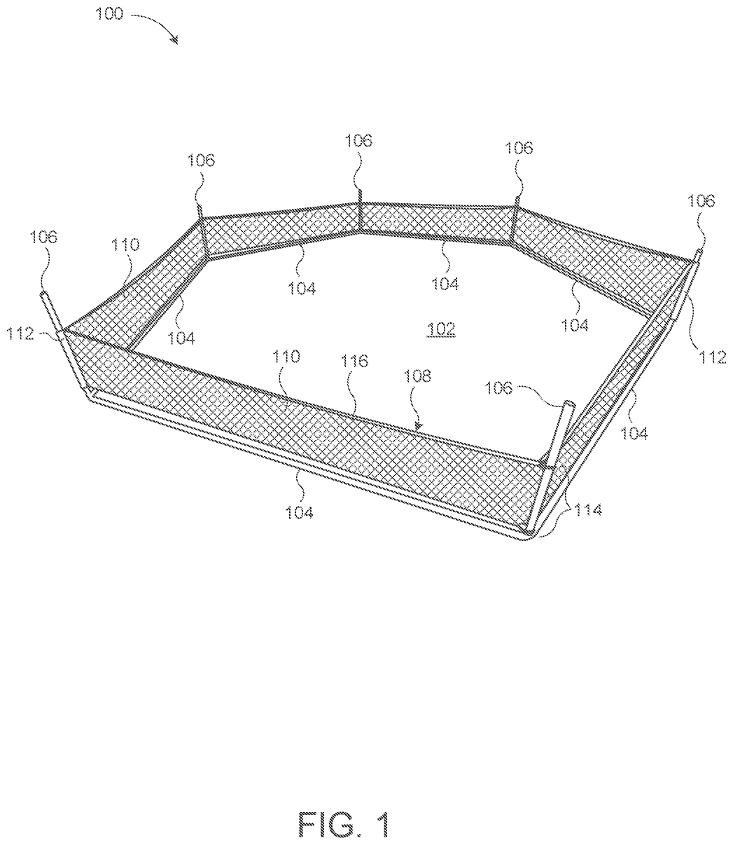

FIG. 1 illustrates a structure 100 for a netted yard game, according to an embodiment. Embodiments of the structure 100 provide a portable and intuitive arrangement for defining a multi-sided game area 102 having relatively low sides that are capable of returning a ball impacting the side of the structure 100.

Embodiments of the structure 100 may include horizontal elements 104 positioned around a perimeter of the game area 102. In some embodiments, a first of the horizontal elements 104 may be coupled to a second of the horizontal elements 104 at one end of the first of the horizontal elements 104 and to a third of the horizontal elements 104 at another end of the first of the horizontal elements 104. In some embodiments, the horizontal elements 104 may be coupled to one another at relative angles. The angle at which the horizontal elements 104 are coupled to one another may be equal or uniform across the structure 100 or may be unique relative to another coupling of the horizontal elements 104.

In some embodiments, the structure 100 may include vertical elements 106 coupled to the horizontal elements 104. In some embodiments, the vertical elements 106 may be coupled to the horizontal elements 104 at or near each intersection of the horizontal elements 104. In some embodiments, the vertical elements 106 may support a partition 108 extending around a perimeter of the game area 102. In some embodiments, the partition 108 may be a net. In other embodiments, the partition 108 may be a rigid or semi-rigid structure. In some embodiments, the partition 108 may be coupled to the vertical elements 104 to support the partition 108 between the vertical elements 106.

In some embodiments, the partition 108 includes multiple panels 110 or sections. For example, the partition 108 may include two panels 110, three panels 110, or six panels 110, etc. In some embodiments, each panel 110 of the partition 108 is identical. In other embodiments, one or more of the panels 110 of the partition 108 may differ from another of the panels 110 of the partition 108 in length, size, material, construction, etc. In other embodiments, the partition 108 is a single piece or panel 110 spanning the entire perimeter of the structure 100.

In some embodiments, the partition 108 may attach to the vertical elements 106 in one or more ways. For example, the partition 108 may couple to one of the vertical elements 106 with a sleeve attachment 112 in which the partition 108 couples to the sleeve attachment 112 and the vertical element 106 inserts into the sleeve attachment 112 to secure the partition 108 relative to the vertical element 106.

In another example, the partition 108 may couple to one or more of the vertical elements 106 with a tension attachment 114. In some embodiments, the tension attachment 114 couples the partition 108 to the vertical element 106 in an adjustable manner in which the distance of the partition 108 from the vertical element 106 may be adjusted to modify a tension in the partition 108. In some embodiments, the tension attachment 114 may include an extension element configured to extend the partition 108 vertically along the vertical element 106 to resist bunching or collapsing of the partition 108.

In some embodiments, the partition 108 may include a cap border 116 extending along at least one of a top edge and a bottom edge of the partition 108. In some embodiments, the cap border 116 may extend vertically on the partition 108 proximate the vertical elements 106. In some embodiments, the cap border 116 is sewn onto the partition 108. In other embodiments, the cap border 116 may be coupled to the partition 108 in a non-sewn manner. In some embodiments, the cap border 116 may be a unified portion of the partition 108 itself.

In some embodiments, the border cap 116 may form a resilient portion of the partition 108 to resist wear, structurally support the partition, provide a visible boundary, reduce a chance of injury, improve setup or takedown, or so forth. In some embodiments, the border cap 116 may have a high visibility coloration or reflectivity. In other embodiments, the border cap 116 may be elasticized to provide a tensioning effect or to reduce the chance of injury. Other embodiments, may include visual markings, logos, regions, etc.

In some embodiments, the partition 108 is separated from the horizontal elements 104 by a gap. In other embodiments, the partition 108 may at least partially run along the horizontal elements 104 to reduce a gap between the partition 108 and the horizontal elements 104. In some embodiments, the partition 108 is coupled to the horizontal elements 104 at one or more points along the horizontal elements 104 to secure the partition 108 relative to the horizontal elements 104 and reduce a chance of forming a gap between the partition 108 and the horizontal elements 104.

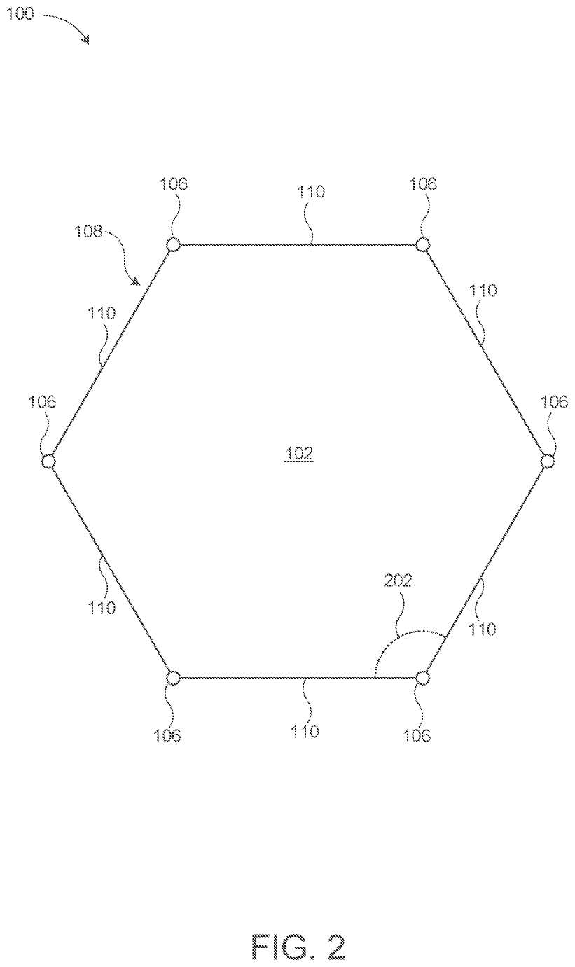

FIG. 2 illustrates an overhead view of the structure 100 of FIG. 1, according to an embodiment. Embodiments may provide a play area 102 that has a recognizable and predictable shape to facilitate a game in an indoor or outdoor environment.

In some embodiments, the partition 108 of the structure 100 may have panels 110 of equal size relative to one another. In other embodiments, one or more of the panels 110 of the partition 108 may be sized differently from another of the panels 110 of the partition 108. In some embodiments, one or more panels 110 may include additional structure such as gate hardware, a ball holder, a scoring apparatus, a tournament board, a rule list, a penalty tracker, or so forth. In some embodiments, one or more of the panels 110 of the partition 108 may be customizable. For example, one or more of the panels 110 may have a first side that is distinct from a second side such that installation/set-up of the structure 100 with the first side turned in may be different from having the second side turned in toward the play area 102.

In some embodiments, the panels 110 may be positioned at an angle 202 relative to one another. For example, the angle 202 may be 60-degrees. In other embodiments, the angle 202 may be more or less than 60-degrees. In some embodiments, the angle 202 is uniform throughout the structure 100. In other embodiments, the angle 202 may be different at one point in the structure than the angle 202 at another point in the structure 100.

In some embodiments, the structure 100 forms a hexagon. In other embodiments, the structure 100 may form a pentagon or other geometric shape. In some embodiments, the shape of the structure 100 may be non-geometric and/or non-symmetrical. In some embodiments, the horizontal elements 104 may form a different shape than that of the partition 108. For example, the horizontal elements 104 may form a circle or other non-hexagonal shape while the partition 108 forms a hexagon or other shape different from that formed by the horizontal elements 104.

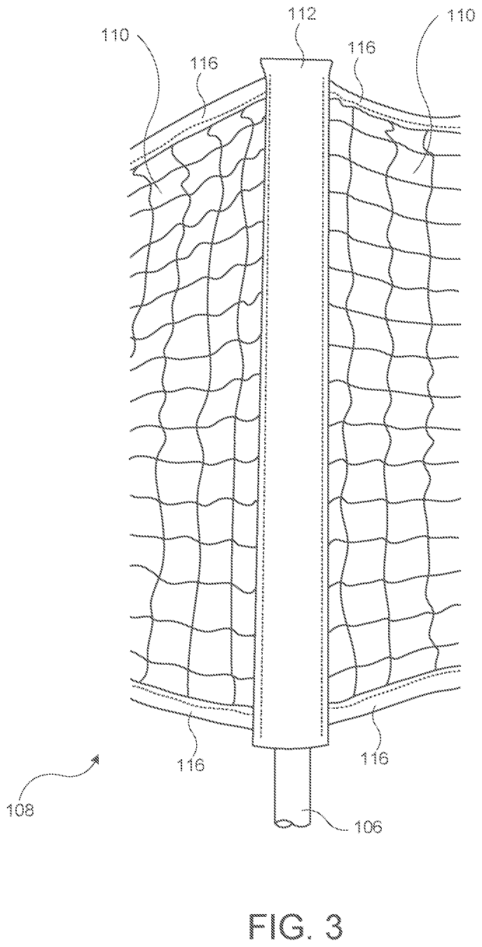

FIG. 3 illustrates a sleeve attachment 112 on a vertical element 106 of the structure 100 of FIG. 1, according to an embodiment. Some embodiments may allow for simple and rapid set-up and takedown of the structure 100.

In some embodiments, the sleeve attachment 112 is shaped to slip onto the vertical element 106. In some embodiments, the sleeve attachment 112 facilitates coupling of the partition 108 to the vertical element 106. The partition 108 may be coupled to the sleeve attachment 112 at a single point or one panel 110 of the partition 108 may connect to the sleeve attachment 112 at one side with a second panel 110 of the partition 108 connecting to the sleeve attachment 112 at a second side of the sleeve attachment 112 opposite the one side.

In some embodiments, a cap border 116 of the partition 108 may couple to the sleeve attachment 112 at one or both of a top edge and a bottom edge of the partition 108. In some embodiments, the sleeve attachment 112 is closed at a top end and open at a bottom end. This may facilitate insertion of the vertical element 106. In some embodiments, the sleeve attachment 112 may be sized to allow the vertical element 106 to reach the closed end of the sleeve attachment 112. In some embodiments, the sleeve attachment 112 may be sized to accept the length of the vertical element 106 without the vertical element 106 impinging at the closed end of the sleeve attachment 116.

In some embodiments, the sleeve attachment 116 may be formed with a strip of material doubled over to form the closed end and sewn, or otherwise joined, along the edges to close the sleeve attachment 116 and form an internal space to receive the vertical element 106. In some embodiments, the same closure mechanism (sewing, adhesive, welding, etc.) is utilized to join the panels 110 of the partition 108 to the sleeve attachment 112.

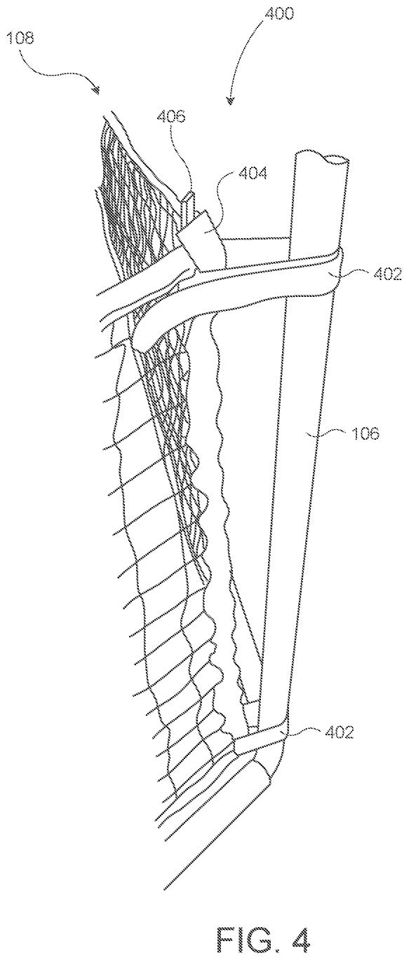

FIG. 4 illustrates a tension element 400 of the structure 100 of FIG. 1, according to an embodiment. Some embodiments, of the tension element 400 may allow for the partition 108 to be tensioned to accommodate play in a variety of environments, ease and forgiveness in set-up, ease of takedown.

In some embodiments, the tension element 400 may be configured to provide tension on the partition 108 relative to the vertical element 106. In some embodiments, the tension element 400 attaches to the vertical element 106 via straps 402. In some embodiments, the straps 402 may be adjustable. For example, the straps 402 may be a hook-and-loop, a tie, a cinch, a ratchet, an elastic, a drawstring, or other adjustable or dynamic arrangement to allow the partition 108 to be drawn toward, or released away from, the vertical element 106.

In some embodiments, the tension element 400 may include a stiffener sleeve 404. The stiffener sleeve 404 may be sized to facilitate housing a stiffener element 406. In some embodiments, the stiffener element 406 may be provided in the tension element 400 to reduce bunching or collapsing of the partition 108 at the vertical element 106. In some embodiments, the stiffener element 406 may be a rigid and elongated element. For example, the stiffener element 406 may include natural or synthetic materials or a combination of natural and synthetic materials such as wood, metal, plastic, rubber, or so forth.

In some embodiments, the stiffener element 406 may be removable from the stiffener sleeve 404. For example, the stiffener sleeve 404 may be open at one end to allow the stiffener element 406 to be inserted into the stiffener sleeve 404. In some embodiments, the stiffener sleeve 404 may remain open or may include a cap or hood to close over the stiffener element 406 to retain the stiffener element 406 or reduce a chance of injury resulting from contact with the stiffener element 406. In some embodiments, the stiffener element 406 may be non-removably installed within the stiffener sleeve 404. In other embodiments, the stiffener element 406 and the stiffener sleeve 404 may be a single unified structure. In some embodiments, the stiffener sleeve 404 may be omitted and the stiffener element 406 may couple directly or indirectly to the partition 108 and/or the vertical element 106.

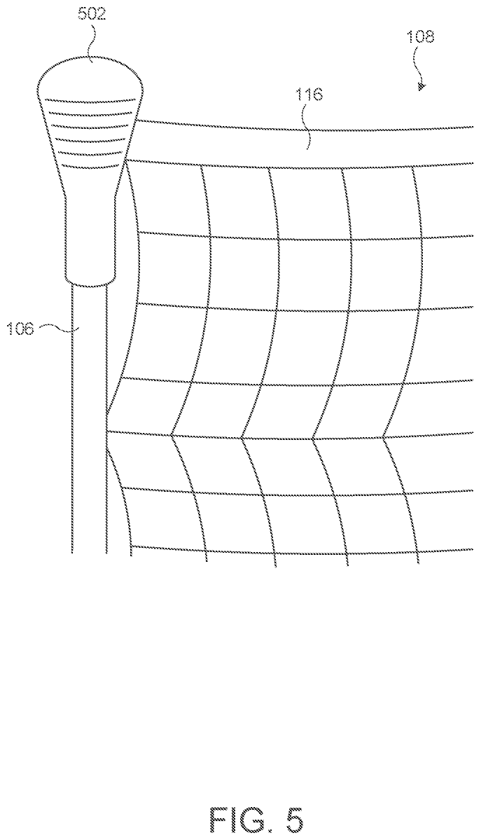

FIG. 5 illustrates an end cap 502 for a vertical element 106 of the structure 100 of FIG. 1, according to an embodiment. Some embodiments provide a quick set-up and takedown for a game with safety considerations.

In some embodiments, the vertical elements 106 may include an end cap 502. The end cap 502 may be positioned on an end of one or more of the vertical elements 106. In some embodiments, the end cap 502 may be shaped to increase a surface area of the vertical elements 106 to reduce a chance of injury or harm to a user or the equipment. In some embodiments, the end cap 502 may be a separate structure from the vertical element 106. In other embodiments, the end cap 502 may be an integrated portion of the vertical element 106. In some embodiments, the end cap 502 may include a material different from a material of the vertical element 106. For example, the safety gap 502 may include a flexible material to improve impact absorption. In other embodiments, the end cap 502 may be similar or identical in material to the vertical element 106.

In some embodiments, the end cap 502 may couple to the partition 108. For example, the partition 108 may couple to the end cap 502 at a cap border 116 of the partition 108. In other embodiments, the end cap 502 may provide adjustability. For example, the end cap 502 may facilitate a height adjustment for the vertical element 106, a tension adjustment for the partition 108, or so forth.

In some embodiments, the end cap 502 may include specific characteristic such as a color, lighting, sound, shape, logo, indicator, or so forth. In some embodiments, the end cap 502 may provide lighting to the play area 102. In other embodiments, the end cap 502 may emit sound.

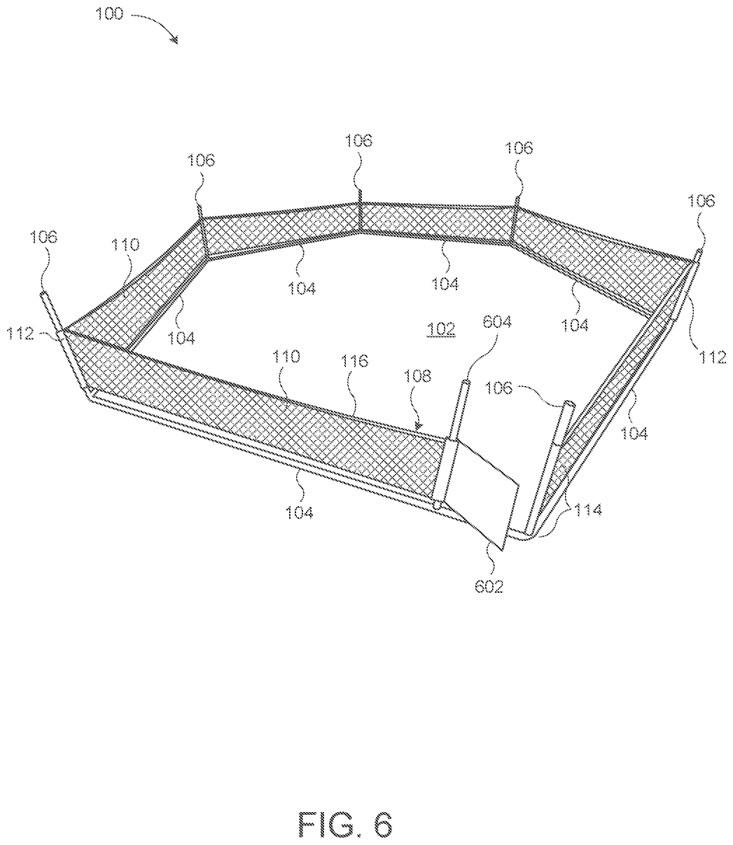

FIG. 6 illustrates a gate element for the structure of FIG. 1, according to an embodiment. Some embodiments may provide easy entry and exit of the structure 100 with reduced risk of tripping, injury, or damaging the structure 100.

In some embodiments, the structure 100 may include a gate 602. The gate 602 may be coupled to a gate support element 604. The gate support element 604 may coupled to a horizontal element 104. In some embodiments, the gate support element 604 may extend approximately perpendicular to the horizontal element 104 and approximately parallel to a vertical element 106. The gate 602 may extend between the gate support element 604 and the vertical element 106. In some embodiments, the gate 602 is removable from the gate support element 604 and/or the vertical element 106. In some embodiments, the gate 602 may be coupled to the gate support element 604 and/or the vertical element 106 via a hook and loop, snap, tie, elastic, strap, or so forth. In some embodiments, the gate 602 may include, or be coupled to, a sleeve for attachment to the at least one of the gate support element 604 and the vertical element 106. In some embodiments, the gate 602 may be coupled to the horizontal element 104. The gate 602 may be opened to admit passage of a player in or out of the structure 100. The gate 602 may be rigid, semi-rigid, or flexible. The gate 602 may include a similar material to the panels 110, the cap border 116, or so forth. In other embodiments, the gate 602 may include a distinct material.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively inclusive elements includes at least one element of the listed elements. However, an example described using a list of alternatively inclusive elements does not preclude another example that includes all of the listed elements. An example described using a list of alternatively inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system comprising:
horizontal elements forming a multi-sided play area bounded by the horizontal elements;
vertical elements extending perpendicularly upward from ends of the horizontal elements; and
a flexible partition coupled to the vertical elements to bound a perimeter of the multi-sided play area by forming panels extending between the vertical elements, each panel having a height corresponding to a height of the vertical elements and a length corresponding to a length of the horizontal elements.

2. The system of claim 1, wherein the flexible partition comprises a net forming the panels.

3. The system of claim 1, wherein the flexible partition is coupled to the vertical elements via a strap.

4. The system of claim 3, wherein the strap comprises an elastic component.

5. The system of claim 3, wherein the strap applies tension between the vertical elements and the flexible partition.

6. The system of claim 1, further comprising a stiffener, wherein the stiffener is configured to:
couple to the flexible partition to reduce vertical collapsing of the flexible partition; and
extend approximately parallel to the vertical elements.

7. The system of claim 6, wherein the stiffener is configured to couple directly to the flexible partition.

8. The system of claim 6, wherein the stiffener is configured to couple directly to a corresponding vertical element to apply tension to the flexible partition.

9. The system of claim 1, further comprising a gate formed in the flexible partition to facilitate passage of a player in or out of the multi-sided play area.

10. The system of claim 9, wherein the gate comprises a hook-and-loop element to open and close the gate.

11. The system of claim 9, wherein the gate comprises:
a gate support element configured to:
extend parallel to the vertical elements; and
couple to a corresponding horizontal element at a distance from a corresponding vertical element; and
a material to extend from the gate support element to the corresponding vertical element to close during play and open to facilitate the passage of the player.

12. The system of claim 11, wherein the gate comprises a closure element to couple to at least one of the gate support element or the corresponding vertical element.

13. The system of claim 1, wherein the flexible partition is coupled directly to a first vertical element of the vertical elements and indirectly to a second vertical element of the vertical elements.

14. A method comprising:
coupling a first end of a first horizontal element to a first vertical element to position the first horizontal element perpendicular to the first vertical element;
coupling a first end of a second horizontal element to the first vertical element to position the second horizontal element perpendicular to the first vertical element and at a non-zero angle relative to the first horizontal element;
coupling a second vertical element to a second end of the second horizontal element to be approximately parallel to the first vertical element; and
coupling a flexible partition to the first vertical element and the second vertical element to extend between the first vertical element and the second vertical element along the second horizontal element to form a multi-sided play area at least partially bounded by the flexible partition.

15. The method of claim 14, further comprising;
coupling a gate support element to one of the first horizontal element or the second horizontal element, the gate support element being perpendicular to the first horizontal element and the second horizontal element and approximately parallel to the first vertical element and the second vertical element; and
coupling a gate to the gate support element and one of the first vertical element or the second vertical element.

16. The method of claim 15, further comprising opening the gate by uncoupling the gate from the gate support element or the one of the first vertical element or the second vertical element.

17. The method of claim 14, wherein the coupling of the flexible partition to the first vertical element and the second vertical element comprises coupling the flexible partition directly to the first vertical element and indirectly to the second vertical element.

18. The method of claim 17, further comprising coupling a strap between the flexible partition and the second vertical element.

19. The method of claim 18, further comprising adjusting a tension of the flexible partition by adjusting a tension of the strap between the flexible partition and the second vertical element.

20. The method of claim 14, wherein the coupling of the first end of the first horizontal element to the first vertical element comprises inserting one of the first end of the first horizontal element into the first vertical element or inserting the first vertical element into the first end of the first horizontal element.
